(19) United States
(12) Patent Application Publication
(10) Pub. No.: US 2017/0086233 A1
(43) Pub. Date: Mar. 23, 2017

(54) CONNECTION METHOD FOR MULTIMEDIA PLAYING DEVICE, MAIN DEVICE, AND CONTROL TERMINAL

(71) Applicant: Guangdong Oppo Mobile Telecommunications Corp., Ltd., Dongguan (CN)

(72) Inventor: Shangbo Lin, Dongguan (CN)

(21) Appl. No.: 15/371,960

(22) Filed: Dec. 7, 2016

Related U.S. Application Data
(63) Continuation of application No. PCT/CN2015/096069, filed on Nov. 30, 2015.

(30) Foreign Application Priority Data
Aug. 20, 2015 (CN) 201510514729.5

(51) Int. Cl. H04W 76/02; H04W 4/00

(52) U.S. Cl. CPC H04W 76/02; H04W 4/008; H04W 84/12

(57) ABSTRACT

The present disclosure provides a connection method for a multimedia playing device, a main device, and a control terminal. The connection method includes: receiving selection information based on a playing device information list from a control terminal, determining a playing device to be connected in accordance with the selection information, and acquiring wireless connection information of the playing device to be connected by a main device; and transmitting the wireless connection information acquired to the control terminal by the main device, whereby the control terminal will establish a wireless communication connection with the playing device to be connected in accordance with the wireless connection information.

### CROSS-REFERENCE TO RELATED APPLICATIONS

This application is a continuation of International Application No. PCT/CN2015/096069, filed on Nov. 30, 2015, which claims the priority of Chinese patent application No. 201510514729.5, filed on Aug. 20, 2015, the disclosures of both of which are herein incorporated by reference in their entireties.

### TECHNICAL FIELD

The present disclosure relates to the field of multimedia playing technology, and particularly to a connection method for a multimedia playing device, a main device, and a control terminal.

### BACKGROUND

Currently, multimedia playing devices are generally integrated with network communication function, and a plurality of multimedia devices in different regions can form a multimedia playing system via a connection network. Typically, a plurality of playing devices of a multimedia playing system can form a private network in a wireless manner, for example, can form the private network via Wireless Mesh network technology, and each playing device can exchange information and data via the private network. Wherein at least one playing device is configured to connect to a router to access the Internet and LAN (Local Area Network) and acquire multimedia data there from, the playing device can be referred to as “main device” of the multimedia playing system while other playing devices can be referred to as “slave device”.

A plurality of multimedia playing devices of a multimedia playing system can play multimedia files individually or synchronously. The plurality of multimedia playing devices can also be divided into multiple playing groups and each group can play different multimedia files so as to provide user with improved use experience.

Mobile terminal (such as Smart phone) conducted as a control terminal can connect with with and control a multimedia playing system via wireless communication. Normally, a mobile terminal can establish a connection with the multimedia playing system via Wireless Fidelity (Wi-Fi); alternatively, the mobile terminal can establish a Bluetooth connection with one multimedia playing device of the multimedia playing system, such that multimedia data stored in the mobile terminal can be sent directly to the multimedia playing device, and the multimedia playing device can in turn sent the multimedia data received to other multimedia playing devices of the system via a private network.

As to the Bluetooth connection, there are some problems such as inconvenient operation and poor user experience required to be addressed.

### SUMMARY

Disclosed herein are implementations of a connection method for a multimedia playing device of a multimedia playing system, comprising receiving selection information based on a playing device information list from a control terminal by a main device, determining a playing device to be connected in accordance with the selection information and acquiring wireless connection information of the playing device to be connected by the main device, and transmitting the wireless connection information acquired to the control terminal by the main device, wherein the control terminal is configured to establish a wireless communication connection with the playing device to be connected in accordance with the wireless connection information, wherein the playing device information list contains a name of the main device and a name of a slave device.

Disclosed herein are also implementations of a main device arranged in a multimedia playing system, comprising a selection information receiving unit, configured to receive selection information based on a playing device information list sent from a control terminal, a playing device determining unit, configured to determine a playing device to be connected in accordance with the selection information, a wireless connection information acquiring unit, configured to acquire wireless connection information of the playing device to be connected, and a wireless connection information transmitting unit, configured to transmit the wireless connection information acquired to the control terminal, wherein the control terminal is configured to establish a wireless communication connection with the playing device to be connected in accordance with the wireless connection information, wherein the playing device information list contains a name of the main device and a name of a slave device of the multimedia playing system.

Disclosed herein are also implementations of a control terminal, comprising a selection information transmitting unit, configured to transmit selection information based on a playing device information list to a main device of a multimedia playing system, wherein the main device is configured to determine a playing device to be connected in accordance with the selection information, acquire wireless connection information of the playing device to be connected, and transmit the wireless connection information acquired to the control terminal, a wireless connection information receiving unit, configured to receive the wireless connection information from the main device, and a wireless communication connection establishing unit, configured to establish a wireless communication connection with the playing device to be connected in accordance with the wireless connection information, wherein the playing device information list contains a name of the main device and a name of a slave device of the multimedia playing system.

### BRIEF DESCRIPTION OF THE DRAWINGS

FIG. 1 is a schematic flowchart illustrating a connection method for a multimedia playing device of a multimedia playing system according to the first implementation of the present disclosure;

FIG. 2 is a schematic flowchart illustrating a connection method for a multimedia playing device of a multimedia playing system according to the second implementation of the present disclosure;

FIG. 3 is a schematic flowchart illustrating a connection method of a music playing device of a music playing system according to the third implementation of the present disclosure;

FIGS. 4A-4B are structure block diagrams illustrating a main device according to the fourth implementation of the present disclosure respectively;

FIGS. 5A-5B are structure block diagrams illustrating a control terminal according to the fifth implementation of the present disclosure respectively;

FIG. 6 is a structure block diagram illustrating a multimedia system according to the sixth implementation of the present disclosure; and

FIG. 7 is a structure block diagram illustrating a multimedia playing device according to the sixth implementation of the present disclosure.

### DETAILED DESCRIPTION

Generally, there are two approaches to establish a Bluetooth connection. In one approach, the user can choose the name of a Bluetooth device desired to be connected manually, and establish a Bluetooth connection through entering a correct password or PIN; in another approach, make one device to acquire Bluetooth connection information of another device via Near Field Communication (NFC) and other technologies and then establish a Bluetooth connection automatically based on the information acquired.

Typically, the above two approaches can be applied to establish a connection between two devices. However, a multimedia playing system is usually composed of multiple playing devices; when it is required to establish a Bluetooth connection between a mobile terminal and a multimedia playing system, in fact, it is required to establish the Bluetooth connection between the mobile terminal and some playing device of the multimedia playing system. The above mentioned second approach requires the user to take the initiative to come close to a multimedia playing device desired to be connected with and therefore is not user-friendly; as a result, the first approach is usually adopted in practice. In addition, in order to avoid the user to manually turn on or turn off Bluetooth function of the multimedia playing device frequently, a Bluetooth unit of the multimedia playing device will be in a normally open state. In this case, numerous Bluetooth unit names can be displayed in the interface of a Bluetooth unit list of the mobile terminal, which includes the Bluetooth unit name of each playing device of the multimedia playing system, the Bluetooth unit name of other Bluetooth devices around the user (such as Bluetooth headsets, Bluetooth watches, or Bluetooth bracelets, etc.), or even the Bluetooth unit name of Bluetooth devices of the neighbor. Numerous Bluetooth unit names appear at the same time will cause confusion for the user to choose, this is because the user does not know which one to choose to connect and it is possible to make a wrong choice; once a wrong choice has occurred, disconnection and re-selection will be required. If the user wants to use one playing group of the multimedia playing system to play multimedia files, the user may have no idea about which playing device of the playing group should be connected. Thus, existing connection approaches between the mobile terminal and multimedia playing devices is inconvenient for the user to use.

Taking into account the above issues, technical schemes of the present disclosure will be described in detail below with refer to implementations in conjunction with accompanying drawings. Implementations described herein are used to explain rather than restrict the present disclosure. Only relevant parts rather than the whole structure of the present disclosure are illustrated in the accompanying drawings.

For ease of explanation, some implementations will be presented as processes or methods hereinafter. Although steps are illustrated in sequence in the flowcharts, some or all of the steps can be performed in parallel, concurrently, or simultaneously. Moreover, the sequence of each step can be rearranged. A process can be terminated once corresponding steps thereof have completed or, a process can still include other additional steps not illustrated in the drawings. A process can correspond to a method, a function, a procedure, a sub-routine, or a sub-program, and the like.

First Implementation

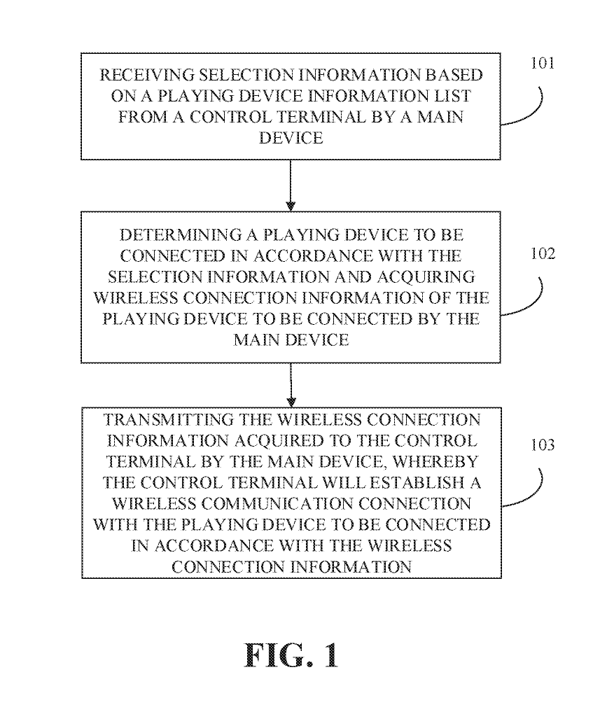

FIG. 1 is a schematic flowchart illustrating a connection method for a multimedia playing device of a multimedia playing system according to the first implementation of the present disclosure. The method can be executed by a main device of a multimedia playing system and can be achieved by hardware and/or software.

As illustrated in FIG.1, the method can begin at block 101.

At block 101, a main device receives selection information based on a playing device information list from a control terminal; wherein the playing device information list contains the name of the main device and the name of a slave device.

As one implementation, a plurality of multimedia playing devices of a multimedia playing system can form a private network via Wi-Fi or other wireless technologies such as Wireless Mesh network technology, and each playing device can exchange information and data through the private network. Among which, at least one playing device can couple to a router in a wired or wireless manner to access the Internet or LAN and acquire multimedia data there from. The at least one playing device mentioned above can be referred to as “main device” of the multimedia playing system; on the other hand, other playing devices of the system can be referred to as “slave device”. The multimedia playing device can be used to play multimedia files such as music, video, and picture.

As an exemplary implementation, the control terminal can be a smart phone, a tablet PC, a laptop computer, or other mobile terminals, it can establish a connection with the private network of the multimedia playing system in a wireless manner such as via Wi-Fi; for example, it can couple to a router which has connected with the main device and then access and control playing devices of the private network of the multimedia playing system. In this implementation, the selection information based on the playing device information list, which is received by the main device from the control terminal, can be transmitted through Wi-Fi. As an example, upon reception of the selection information, an authentication of the control terminal can be conducted; proceed to the next step only when the authentication is successful so as to ensure the security of the multimedia playing system.

As an exemplary implementation, the control terminal can establish a wireless connection with one multimedia playing device of the multimedia playing system and transmit multimedia data stored in the control terminal per se to the multimedia playing device directly. The multimedia playing device can transfer the multimedia data received to other multimedia playing devices of the system via the private network either. The wireless connection referred to herein can include Bluetooth connection, Infrared connection, and other wireless connection manners; hereinafter, take Bluetooth connection as an example. As a traditional manner to establish a Bluetooth connection, an interface of a Bluetooth unit name list is displayed at the control terminal and numerous wireless unit names are shown therein. Each wireless unit name needs to be set in advance in a device that a corresponding wireless unit belongs to, and wireless units can be named in different approaches. In this situation, the user may be confused because he or she may have no idea about which one to choose. In implementations of the present disclosure, the playing device information list contains the name of the main device and the name of a slave device, which can be a device name that has been set uniformly by the control terminal, for example, the device name can be set by system by default or set by user according to actual needs. For example, the name of the main device or the name of the slave device (that is, device name) can include model, location, various performance parameters, and so on (such as supported multimedia format, supported profile, memory, current working status, and the like) of the playing device. For example, the device name of a playing device can be “M101-Living room-MP3, AVI, and WAV” or “M102-Bedroom 2-Playing”. The device name can be updated dynamically, for example, the main device can acquire the current working status and other information of each playing device via the private network and transmit the same to the control terminal, whereby the control terminal can update the name of each corresponding playing device. As an example, the selection information can include the device name of a selected playing device, such as the name of the main device and/or the name of at least one slave device.

Moreover, the playing device information list can also include the name of a playing group that the main device belongs to and the name of a playing group that the slave device belongs to. A plurality of multimedia playing devices of a multimedia playing system can play multimedia files separately or synchronously. The plurality of multimedia playing devices can be divided into multiple playing groups and each playing group can play different multimedia files. Therefore, the playing device information list can include the name of a playing group that a playing device belongs to. Correspondingly, the selection information can be playing group selection information and the name of a selected playing group can be included therein.

At block 102, the main device determines a playing device to be connected in accordance with the selection information and acquires wireless connection information of the playing device to be connected.

As an example, the playing device to be connected can be a playing device that the control terminal wants to connect with. If the device name of a selected playing device (that is, the playing device to be connected) is contained in the selection information, the main device can determine the playing device to be connected in accordance with the device name; if the selection information is specified as playing group selection information, the main device can determine the playing device to be connected in accordance with the playing group selection information and a predetermined manner. For example, the main device can determine a selected playing group in accordance with the playing group selection information and then select the playing device to be connected from this playing group in the predetermined manner. Based on the predetermined manner, the main device can make a selection randomly or according to parameter information such as working status of playing devices.

As one implementation, after determining the playing device to be connected, the main device can acquire the wireless connection information of the playing device to be connected via the private network. For example, the playing device can be a slave device, in this situation, the slave device can transmit Bluetooth connection information thereof to the main device; on the other hand, the playing device can be the main device, and in such a situation, the main device can acquire its own Bluetooth connection information directly. The Bluetooth connection information can include the name of a Bluetooth unit, the Media Access Control (MAC) address of a Bluetooth unit, a connection password, and other information.

Taking into account energy saving, Bluetooth units of each playing device can be turned off in advance, and the operation of this step can be implemented as: the main device determines the playing device to be connected in accordance with the selection information and control this playing device to turn on wireless connection function; the main device acquires wireless connection information of the playing device to be connected. That is to say, after determining the playing device to be connected, the main device can control the determined playing device to be connected to turn on wireless connection function, for example, turn on a Bluetooth unit. For example, if the playing device to be connected is a slave device, the main device can send relevant control data to the playing device to be connected to turn on wireless connection function, whereby the playing device to be connected will turn on wireless connection function in accordance with the control data. If the playing device to be connected is the main device per se, the main device can turn on wireless connection function thereof directly.

At block 103, the main device transmits the wireless connection information acquired to the control terminal, whereby the control terminal can establish a wireless communication connection with the playing device to be connected in accordance with the wireless connection information.

As an example, the main device transmit the acquired information such as the name of a Bluetooth unit, the MAC address of a Bluetooth unit, and a connection password to the control terminal, whereby the control terminal can establish a Bluetooth communication connection with the playing device to be connected in accordance with the above mentioned information. Once the Bluetooth connection is established, the control terminal can transmit multimedia data to the connected playing device via Bluetooth, whereby the connected playing device can play multimedia files corresponding to the multimedia data. If simultaneous playing of a playing group is required, the Bluetooth connected playing device can transmit the multimedia data received to other playing devices of the same playing group, whereby simultaneous playing of multiple playing devices of the playing group can be achieved. Moreover, the control terminal can transmit information (such as song name, network music server storing the song, Uniform Resource Locator (URL), and other information) of multimedia files desired to be played to the Bluetooth connected playing device thereof such that the playing device can couple to a corresponding network music server as well as download audio data and play the song.

Through the connection method of a multimedia playing device described above, a main device can receive selection information based on a playing device information list from a control terminal, among which the playing device information list contains the name of the main device and the name of a slave device; the main device determines a playing device to be connected in accordance with the selection information and acquires wireless connection information of the determined playing device to be connected, and then transmits the wireless connection information acquired to the control terminal, whereby the control terminal can establish a wireless communication connection with the playing device to be connected in accordance with the wireless connection information. With aid of the technical schemes described above, it is not necessary for the user to know connection information (such as the name of a wireless unit and password) desired for establishing a wireless communication connection of the playing device to be connected. Automatic connection between the control terminal and the playing device to be connected can be achieved via selecting the name of the playing device to be connected from the playing device information list of the control terminal. It can be seen that the process can be performed easily and quickly, and therefore user experience can be effectively improved.

Second Implementation

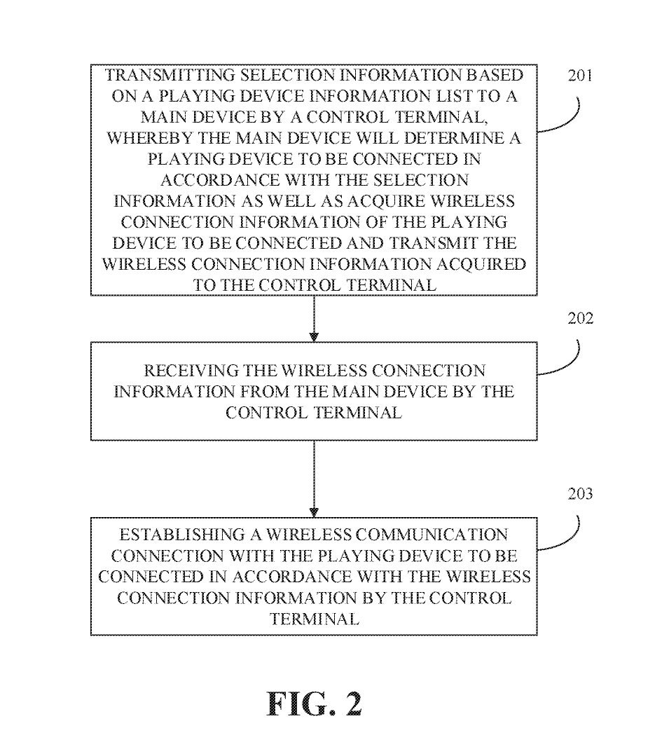

FIG. 2 is a schematic flowchart illustrating a connection method for a multimedia playing device of a multimedia playing system according to the second implementation of the present disclosure. This method can be executed by a control terminal configured to control a multimedia playing system and can be implemented with hardware and/or software. As illustrated in FIG. 2, the method can begin at block 201.

At block 201, the control terminal transmits selection information based on a playing device information list to a main device, whereby the main device will determine a playing device to be connected in accordance with the selection information as well as acquire wireless connection information of the playing device to be connected and then transmit the wireless connection information acquired to the control terminal.

As an example, the playing device information list contains the name of the main device and the name of a slave device.

Similar to the implementation described above, the control terminal used in this implementation can be a smart phone, a tablet PC, a laptop computer, or other mobile terminals, it can establish a connection with the private network of the multimedia playing system in a wireless manner such as via Wi-Fi, for example, it can couple to a router which has been connected with the main device and then access and control playing devices of the private network of the multimedia playing system.

As an example, the playing device information list can still include the name of a playing group that the main device belongs to and the name of a playing group that a slave device belongs to. Based on this, the operation performed at block 201 can be performed as follows: the control terminal transmits playing group selection information based on the playing device information list to the main device, whereby the main device can determine the playing device to be connected in accordance with a predetermined manner and the playing group selection information, acquire wireless connection information of the playing device to be connected, and transmit the acquired wireless connection information to the control terminal.

For example, the wireless connection information referred to herein can be Bluetooth connection information, such as the name of a Bluetooth unit, the MAC address of a Bluetooth unit, a connection password, and other information.

As one exemplary implementation, prior to the operation performed at block 201, the method can further include the following processes: the control terminal displays the playing device information list and generate the selection information based on the playing device information list in accordance with a selection operation triggered by user. For example, the playing device information list, which contains the device name of each playing device and the name of respective playing group that each playing device belongs to, is displayed on a screen of the control terminal, from which user can choose a playing device or a playing group to be connected to the control terminal according to actual needs. In practical operation, once the device name of a playing device on the screen is clicked by user, it is considered that a selection operation of the playing device is triggered by user; similarly, once the name of a playing group is clicked, it is considered that a selection operation of the playing group is triggered.

At block 202, the control terminal receives the wireless connection information sent by the main device.

At block 203, the control terminal establishes a wireless communication connection with the playing device to be connected in accordance with the wireless connection information.

Through the connection method of a multimedia playing device described above, a control terminal can transmit selection information based on a playing device information list to a main device and receive, from the main device, wireless connection information of a playing device to be connected corresponding to the selection information; the control terminal establishes a wireless communication connection with the playing device to be connected in accordance with the wireless connection information. The playing device information list contains the name of the main device and the name of a slave device. With aid of the technical schemes described above, it is not necessary for the user to know connection information (such as the name of a wireless unit and password) required for establishing a wireless communication connection of the playing device to be connected. Automatic connection between the control terminal and the playing device to be connected can be achieved via selecting the name of the playing device to be connected from the playing device information list of the control terminal. It can be seen that the process can be implemented easily and quickly, and user experience can be effectively improved.

Third Implementation

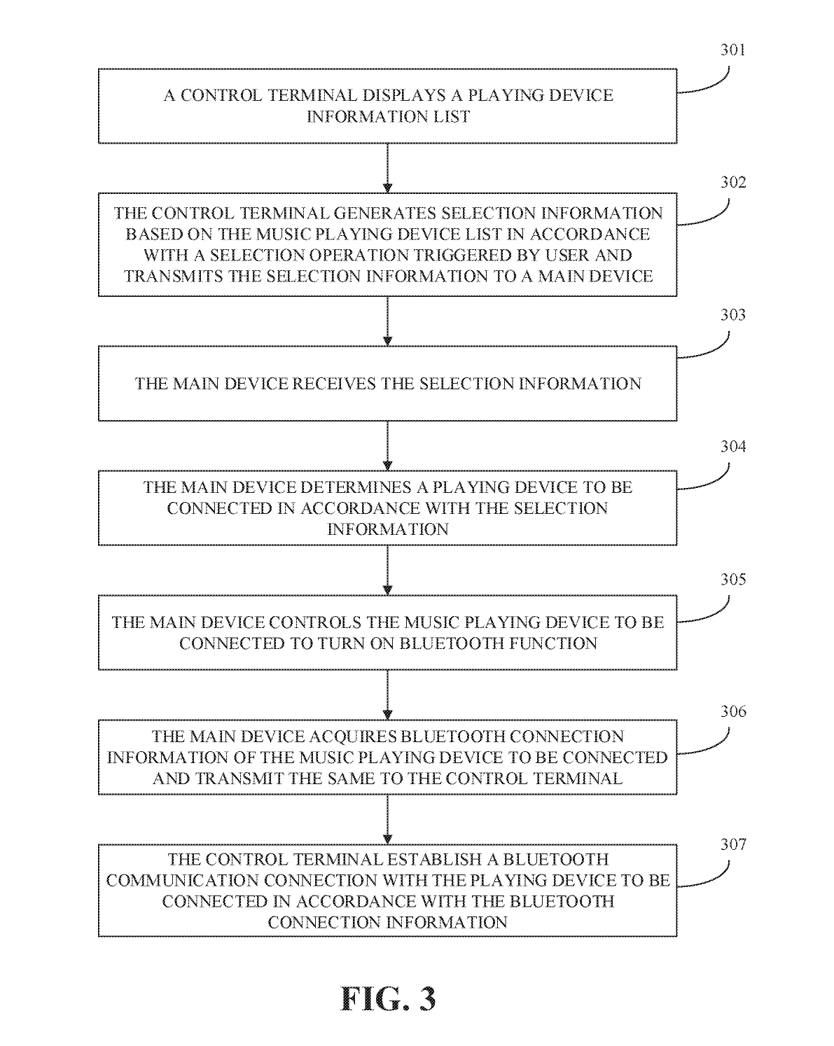

FIG. 3 is a schematic flowchart illustrating a connection method of a music playing device of a music playing system according to the third implementation of the present disclosure. The technical scheme of this implementation is proposed on the basis of the implementations described above, and hereinafter, take a music playing system as an example of the multimedia playing system for further explanation. As illustrated in FIG. 3, the method can being at block 301.

At block 301, a control terminal displays a playing device information list.

At block 302, the control terminal generates selection information based on the music playing device list in accordance with a selection operation triggered by user and transmits the selection information to a main device.

As an example, the user can select a music playing device or a playing group desired to be connected from the playing device information list displayed on a screen of the control terminal.

At block 303, the main device receives the selection information.

At block 304, the main device determines a playing device to be connected in accordance with the selection information.

As an example, if the main device judges that the name of the determined music playing device (that is, the multimedia playing device mentioned above) is contained in the selection information, the music playing device can be determined as the music playing device to be connected directly; otherwise, if the main device judges that only the name of a playing group is contained in the selection information, it will choose a music playing device randomly from the playing group as the music playing device to be connected.

At block 305, the main device controls the music playing device to be connected to turn on Bluetooth function.

At block 306, the main device acquires Bluetooth connection information of the music playing device to be connected and transmit the same to the control terminal.

At block 307, the control terminal establishes a Bluetooth communication connection with the playing device to be connected in accordance with the Bluetooth connection information.

Through the connection method of a music playing device of a music playing system described above, it is not necessary for the user to know connection information (such as the name of a wireless unit and password) used to establish a Bluetooth communication connection of the music playing device to be connected. Automatic connection between the control terminal and the music playing device to be connected can be achieved via selecting the device name of the music playing device to be connected or the name of a playing group that the music playing device belongs to from the playing device information list of the control terminal. It can be seen that the process can be implemented easily and quickly, and user experience can be effectively improved.

Forth Implementation

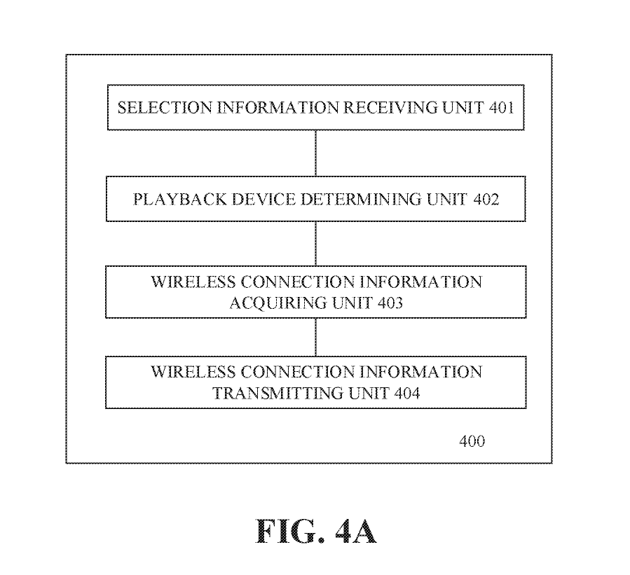

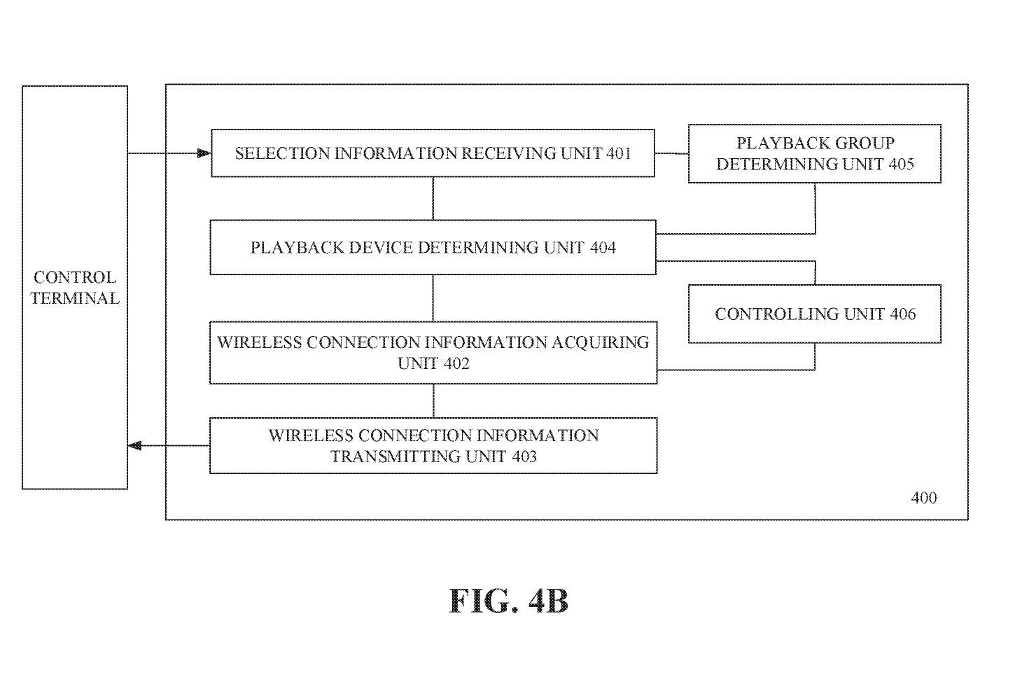

FIG. 4A is a structure block diagram illustrating a main device according to the fourth implementation of the present disclosure. The main device can be arranged in a multimedia playing system, and as illustrated in FIG. 4A, a main device 400 can include a selection information receiving unit 401 (such as a receiver), a playing device determining unit 404 (such as a processor), a wireless connection information acquiring unit 402 (such as an extractor), and a wireless connection information transmitting unit 403 (such as a transmitter).

The selection information receiving unit 401 is configured to receive selection information based on a playing device information list from a control terminal; the playing device information list contains the name of the main device and the name of a slave device of the multimedia playing system. The playing device determining unit 404 is configured to determine a playing device to be connected in accordance with the selection information, and the wireless connection information acquiring unit 402 is configured to acquire wireless connection information of the playing device to be connected. The wireless connection information transmitting unit 403 is configured to transmit the wireless connection information acquired to the control terminal, whereby the control terminal will establish a wireless communication connection with the playing device to be connected in accordance with the wireless connection information.

On the basis of the main device described above, the playing device information list can still contain the name of a playing group that the main device belongs to and the name of a playing group that a slave device belongs to, and the selection information is playing group selection information comprising the name of a selected playing group. Based on this, the selection information receiving unit 401 is further configured to receive playing group selection information based on the playing device information list from the control terminal. The main device further comprises a playing group determining unit 405 (such as a processor), which is further configured to determine the selected playing group in accordance with the playing group selection information. The playing device determining unit 404 is further configured to determine the playing device to be connected of the selected playing group determined by the playing group determining unit 405 in a predetermined manner. The predetermined manner comprises but not limited to select randomly or select in accordance with parameter information of each playing device comprised in the selected playing group.

As one implementation, as illustrated in FIG. 4B, the main device 400 can further include a controlling unit 406 (such as a controller), which is configured to control the playing device to be connected to turn on wireless connection function after the playing device to be connected has been determined by the playing device determining unit 404.

As an example, the wireless connection information can include Bluetooth connection information.

Fifth Implementation

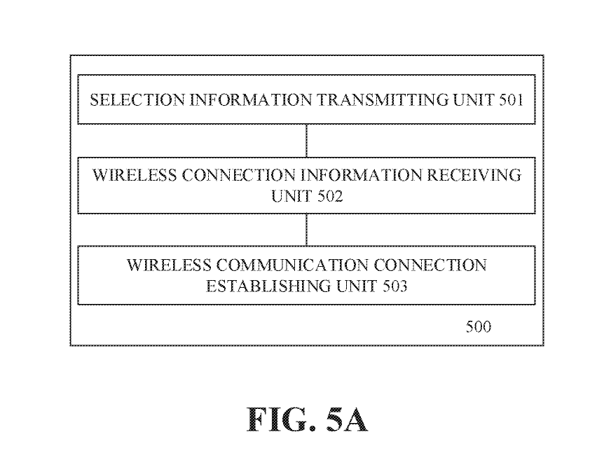

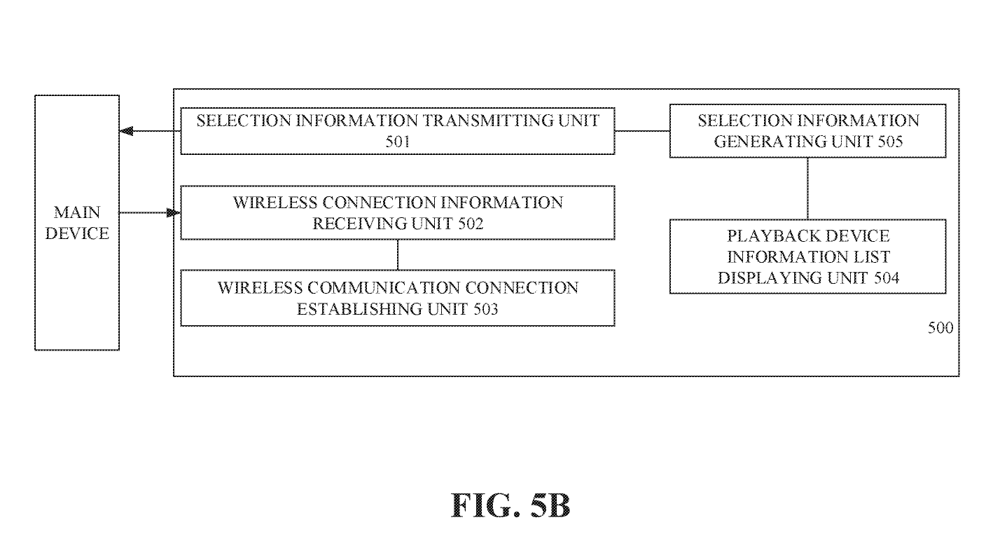

FIG. 5A is a structure block diagram illustrating a control terminal according to the fifth implementation of the present disclosure. As illustrated in FIG. 5A, the control terminal 500 includes a selection information transmitting unit 501 (such as a transmitter), a wireless connection information receiving unit 502 (such as a receiver), and a wireless communication connection establishing unit 503 (such as a communicator).

The selection information transmitting unit 501 is configured to transmit selection information based on a playing device information list to a main device of a multimedia playing system, whereby the main device will determine a playing device to be connected in accordance with the selection information as well as acquire wireless connection information of the playing device to be connected and transmit the wireless connection information acquired to the control terminal; wherein the playing device information list contains the name of the main device and the name of a slave device of the multimedia playing system. The wireless connection information receiving unit 502 is configured to receive the wireless connection information from the main device. The wireless communication connection establishing unit 503 is configured to establish a wireless communication connection with the playing device to be connected in accordance with the wireless connection information.

As an example, the playing device information list can further contain the name of a playing group that the main device belongs to and the name of a playing group that a slave device belongs to. Based on this, the selection information transmitting unit 501 is configured to transmit playing group selection information based on the playing device information list to the main device. In the playing group selection information, the name of a selected playing group can be contained. On the main device side, it can determine the playing device to be connected in accordance with the playing group selection information and a predetermined manner. For example, the main device can determine the selected playing group in accordance with the playing group selection information and then select the playing device to be connected from this playing group in the predetermined manner. Based on the predetermined manner, the main device can make a selection randomly or according to parameter information such as working status of playing devices. Thereafter, as described above, the main device can acquire wireless connection information of the playing device to be connected and transmit the wireless connection information acquired to the control terminal.

On the basis of the structure described above, as illustrated in FIG. 5B, the control terminal 500 can further include a playing device information list displaying unit 504 and a selection information generating unit 505 (such as a generator). The playing device information list displaying unit 504 (such as a display) can be configured to display the playing device information list before the selection information based on the playing device information list is transmitted to the main device by the selection information transmitting unit 501. The selection information generating unit 505 is configured to generate the selection information based on the playing device information list in accordance with a selection operation triggered by user.

As an exemplary implementation, the wireless connection information includes Bluetooth connection information.

Sixth Implementation

According to the sixth implementation of the present disclosure, it is provided a multimedia system, which includes at least one main device according to implementations of the present disclosure, at least one control terminal according to implementations of the present disclosure, and at least one slave device.

The multimedia system includes a multimedia playing system and a control terminal; the main device and the slave device mentioned before are included in the multimedia playing system, and the control terminal is configured to control the multimedia playing system. Generally, one main device is arranged in the multimedia playing system; however, if there is a large number of a slave device, multiple main devices can be deployed correspondingly. Similarly, in general, one control terminal is arranged in the multimedia playing system; however, if there are more than one users want to control the multimedia playing system, multiple control terminals can be deployed. That is to say, multiple control terminals are allowed to connect with the main device via a Wi-Fi connection, and the multiple control terminals are allowed to establish a wireless communication connection such as Bluetooth connection with multiple multimedia playing devices of the multimedia playing system simultaneously.

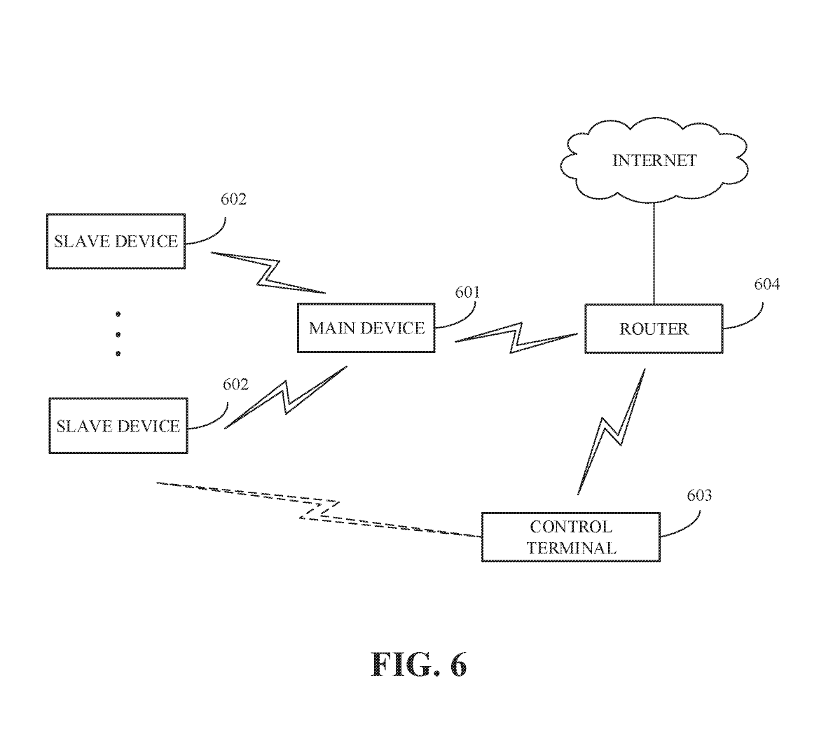

FIG. 6 is a structure block diagram illustrating the multimedia system according to the sixth implementation of the present disclosure. As illustrated in FIG. 6, the multimedia system includes a main device 601, at least one slave device 602, and a control terminal 603, for ease of explanation, only one main device and only one control terminal is shown in the figure, but the present disclosure is not limited thereto.

The control terminal 603 is configured to transmit selection information based on a playing device information list to the main device 601, receive wireless connection information from the main device 601, and establish a wireless communication connection with a playing device to be connected (the main device 601 or any slave device 602) in accordance with the wireless connection information. The main device 601 is configured to receive selection information based on the playing device information list sent from the control terminal 603, determine the playing device to be connected in accordance with the selection information, acquire wireless connection information of the playing device to be connected, and transmit the wireless connection information acquired to the control terminal 603. The playing device information list contains the name of the main device 601 and the name of the slave device 602.

For example, the main device 601 and a router 604 can be connected via Wi-Fi, the main device 601 and the slave device 602 can connect to form a private network via Wireless Mesh network technology. The control terminal 603 can couple to the router 604 via Wi-Fi either. The control terminal 603 can connect with one playing device of the multimedia playing system via Bluetooth.

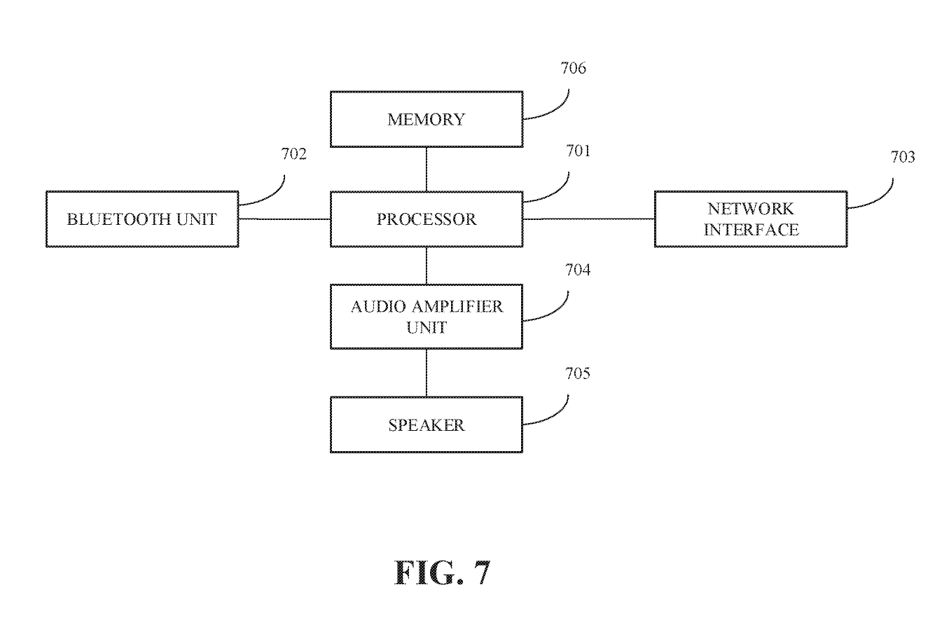

Design of the internal structure of the multimedia playing device will be described in detail below with refer to FIG. 7, which is a structure block diagram illustrating the multimedia playing device according to the sixth implementation.

As illustrated in FIG. 7, the multimedia playing device can be provided with a processor 701, a Bluetooth unit 702, a network interface 703, an audio amplifier unit 704, a speaker 705, and a memory 706.

The processor 701, as the core of the playing device, is configured to perform control program and communicate with peripheral functional units so as to coordinate the work of each unit. The Bluetooth unit 702 is responsible for Bluetooth communication, whereby the playing device can establish a connection with another device (such as a smart phone conducted as a control terminal) equipped with Bluetooth function via Bluetooth. The Bluetooth unit 702 is further configured to acquire audio data or control data and transfer the same to the processor 701; similarly, the Bluetooth unit 702 is further configured to transfer audio data and control data transmitted from the processor 701 to other Bluetooth equipment.

The network interface 703 can be a wired network interface or a wireless network interface complied with 802.11 standards. Via the network interface 703, the processor 701 can connect to the Internet and acquire network streaming media data. Furthermore, via the network interface 703, especially the network interface 703 in a wireless manner, multiple playing devices can form a wireless multimedia playing system, that is, a private network, whereby simultaneous playing of multimedia can be achieved. Each control terminal can access the multimedia playing system through Wi-Fi and control the multimedia playing system per se as well as playing devices of the system.

The audio amplifier unit 704 is configured to receive audio data decoded or Digital/Analog converted by the processor 701. The audio amplifier unit 704 can perform power amplification on analog audio signals transmitted from the processor 701 so as to drive the speaker 705. The speaker 705 is a sound reduction component, and in the multimedia playing device, one or more speakers can be provided. The memory 706 is configured to store programs performed by the processor 701 and some configuration data of the multimedia playing system, for example, network connection data, volume information, group information, and multimedia lists to be played. As one implementation, the functional units are included in the main device and the slave device respectively; in the multimedia playing system, a playing device configured to establish a wired or wireless connection with the router via the network interface 703 directly will be referred to as “main device”, and other playing devices will be referred to as “slave device”. The slave devices will form the private network together with the main device via the network interface 703.

According to another implementation of the present disclosure, it is provided a computer readable storage medium, configured to store one or more programs, when executed by an apparatus, the one or more programs adapted to cause the apparatus to perform the connection method of a multimedia playing device of a multimedia playing system described above.

The term “computer readable storage medium” can be referred to as a non-volatile computer-readable storage medium or tangible computer-readable medium either. Examples of computer readable storage medium include but not limited to magnetic hard disk drive, solid state hard disk, flash memory, USB thumb drive, RAM, ROM, magneto-optical disk, and the register file of the processor.

The term “computer readable-storage medium” also refers to various recording media capable of being accessed by a computer device via a network or communication link. Furthermore, “computer readable storage medium” can be multiple computer readable storage mediums of the same computer system or distributed among multiple computer systems or computing devices.

The main device, the control terminal, the multimedia system and other equipment described above have corresponding functional units and therefore can perform the connection method of a multimedia playing device of a multimedia playing system according to implementations of the present disclosure respectively, and corresponding advantages can be obtained. For details of the equipment, please refer to the description of the connection method of a multimedia playing device of a multimedia playing system according to any implementation described above.

The foregoing descriptions are merely exemplary implementations of the present disclosure, and not intended for any restriction. Various modifications and alterations may be made to the present disclosure for those skilled in the art. Any modification, equivalent substitution, improvement or the like made within the spirit and principle of the present disclosure shall fall into the protection scope of the present disclosure.

What is claimed is:

1. A method for connecting a multimedia playing device of a multimedia playing system, comprising:
receiving selection information based on a playing device information list from a control terminal by a main device;
determining a playing device to be connected in accordance with the selection information and acquiring wireless connection information of the playing device to be connected by the main device; and
transmitting the wireless connection information acquired to the control terminal by the main device, wherein the control terminal is to establish a wireless communication connection with the playing device to be connected in accordance with the wireless connection information, wherein the playing device information list contains a name of the main device and a name of a slave device.

2. The method of claim 1, wherein the playing device information list comprises a name of a playing group that the main device belongs to and a name of a playing group that the slave device belongs to, the selection information is playing group selection information containing a name of a selected playing group.

3. The method of claim 2, wherein determining the playing device to be connected in accordance with the selection information by the main device comprises:
determining the selected playing group in accordance with the playing group selection information; and selecting the playing device to be connected from the selected playing group in a predetermined manner.

4. The method of claim 3, wherein the predetermined manner comprises selecting randomly or selecting in accordance with parameter information of each playing device comprised in the selected playing group.

5. The method of claim 1, wherein after determining the playing device to be connected in accordance with the selection information, the method further comprises:
controlling the playing device to be connected to turn on wireless connection information by the main device.

6. The method of claim 1, wherein the wireless connection information comprises Bluetooth connection information.

7. A main device arranged in a multimedia playing system, comprising:
a selection information receiving unit, configured to receive selection information based on a playing device information list sent from a control terminal;
a playing device determining unit, configured to determine a playing device to be connected in accordance with the selection information;
a wireless connection information acquiring unit, configured to acquire wireless connection information of the playing device to be connected; and
a wireless connection information transmitting unit, configured to transmit the wireless connection information acquired to the control terminal, wherein the control terminal is to establish a wireless communication connection with the playing device to be connected in accordance with the wireless connection information, wherein the playing device information list contains a name of the main device and a name of a slave device of the multimedia playing system.

8. The main device of claim 7, wherein the playing device information list comprises a name of a playing group that the main device belongs to and a name of a playing group that the slave device belongs to, and the selection information is playing group selection information containing a name of a selected playing group.

9. The main device of claim 8, further comprising:
a playing group determining unit, configured to determine the selected playing group in accordance with the playing group selection information, wherein the playing device determining unit is further configured to determine the playing device to be connected of the selected playing group determined by the playing group determining unit in a predetermined manner.

10. The main device of claim 9, wherein the predetermined manner comprises selecting randomly or selecting in accordance with parameter information of each playing device comprised in the selected playing group.

11. The main device of claim 7, further comprising:
a controlling unit, configured to control the playing device to be connected to turn on wireless connection function.

12. The main device of claim 7, wherein the wireless connection information comprises Bluetooth connection information.

13. A control terminal, comprising:
a selection information transmitting unit, configured to transmit selection information based on a playing device information list to a main device of a multimedia playing system, wherein the main device is to determine a playing device to be connected in accordance with the selection information, acquire wireless connection information of the playing device to be connected, and transmit the wireless connection information acquired to the control terminal;
a wireless connection information receiving unit, configured to receive the wireless connection information from the main device; and
a wireless communication connection establishing unit, configured to establish a wireless communication connection with the playing device to be connected in accordance with the wireless connection information, wherein the playing device information list contains a name of the main device and a name of a slave device of the multimedia playing system.

14. The control terminal of claim 13, wherein the playing device information list comprises a name of a playing group that the main device belongs to and a name of a playing group that the slave device belongs to, and the selection information is playing group selection information containing a name of a selected playing group.

15. The control terminal of claim 13, further comprising:
a playing device information list displaying unit, configured to display the playing device information list before the selection information based on the playing device information list being transmitted to the main device; and
a selection information generating unit, configured to generate the selection information based on the playing device information list in accordance with a selection operation triggered by a user.

16. The control terminal of claim 13, wherein the wireless connection information comprises Bluetooth connection information.
